(19) United States
(12) Patent Application Publication
(10) Pub. No.: US 2022/0025702 A1
(43) Pub. Date: Jan. 27, 2022

(54) LADDER ASSEMBLY

(71) Applicant: Casey Armand Hebert, Prairieville, LA (US)

(72) Inventor: Casey Armand Hebert, Prairieville, LA (US)

(21) Appl. No.: 17/383,899

(22) Filed: Jul. 23, 2021

Related U.S. Application Data
(60) Provisional application No. 63/055,611, filed on Jul. 23, 2020.
(60) Provisional application No. 63/172,550, filed on Apr. 8, 2021.

(51) Int. Cl. E06C 1/34; E06C 1/38; E06C 7/08; E06C 7/06; A63B 27/00

(52) U.S. Cl. CPC E06C 1/34; E06C 1/381; A63B 27/00; E06C 7/06; E06C 7/082

(57) ABSTRACT

A ladder assembly for use with a tree or other vertical support includes a first tube and a second tube that is nestable within the first tube. The second tube includes at least one movable step that is movable to one end of the tube to enable almost full insertion of the second tube into the first tube for compact storage and, when the tubes are separated from one another, the movable step is movable to the other end of the tube to provide an ideal step position for a climber. The ladder assembly achieves the same functionality as a telescoping pole but with fewer tube sections because the tubes are separable.

### CROSS-REFERENCE TO RELATED APPLICATIONS

This application claims the benefit of U.S. Provisional Patent Application No. 63/055,611, filed Jul. 23, 2020, and U.S. Provisional Patent Application No. 63/172,550, filed Apr. 8, 2021, both of which are hereby incorporated by reference in their entireties.

### TECHNICAL FIELD

This disclosure relates to portable extension ladders.

### BACKGROUND

Hunters and wildlife observers often climb trees in order to obtain a beneficial vantage point and to remove themselves from the line of sight of animals. For example, many hunters attach platforms and/or seats (sometimes referred to as “deer stands”) to trees to support themselves at an elevated position off the ground. Other hunters may use a harness to connect themselves to a tree in an elevated position in what is referred to as “saddle hunting.”

Hunters may use a climbing device to reach a deer stand or the desired height for saddle hunting. Climbing devices such as ladders must have a plurality of horizontally extending steps spaced sufficiently closely to each other such that, when climbing the device, a climber can comfortably and effortlessly reach steps above the user to push or pull himself or herself up. Steps that have excessive vertical distance between them are out of reach of the climber or make climbing more difficult compared to steps being more closely spaced to each other vertically.

### SUMMARY

A ladder assembly includes first and second tubes. The first tube has first and second step members operatively connected thereto. The second tube has a third and fourth step member operatively connected thereto. The third step member is selectively slidable along the length of the second tube. The fourth step member is operatively connected to one end of the second tube.

The second tube is nestable or insertable into the interior space defined by the first tube. The slidability of the third step member enables the third step member to be moved to allow for fuller insertion of the second tube into the first tube and then returned to its ideal location on the second tube for ease of climbing by a hunter or other user when the first and second tubes are separated from each other.

The ladder assembly provided herein enables a hunter or other user to reach a height in a tree with fewer tubes than would be required with a telescoping pole with steps. More specifically, because the tubes of the ladder assembly are separable, they can be spaced apart vertically from each other while still providing an appropriate vertical distance between step members for the hunter to climb. Thus, the ladder assembly provides the same functionality as a telescoping pole with steps but with fewer parts and significantly lighter weight, which is important when carrying the ladder assembly to remote areas.

A corresponding method of using the ladder assembly is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, perspective view of a ladder assembly having a telescoping pole and a plurality of step members in a compact configuration;

FIG. 2 is another schematic, perspective view of the ladder assembly of FIG. 1 in the compact configuration with some step members removed for clarity;

FIG. 3 is a schematic, perspective view of the telescoping pole in a retracted configuration;

FIG. 4 is a schematic, perspective view of the pole of FIG. 3 in an elongated configuration;

FIG. 5 is a schematic, perspective view of a portion of the ladder assembly of FIG. 1 in an extended configuration;

FIG. 6 is a schematic, cross-sectional, side view of a portion of the telescoping pole of FIG. 1;

FIG. 7 is a schematic, perspective, exploded view of another ladder assembly according to an alternative embodiment;

FIG. 8 is schematic, top view of a step member of the ladder assembly of FIG. 7;

FIG. 9 is a schematic, perspective view of the ladder assembly of FIG. 7 in a retracted configuration;

FIG. 10 is a schematic, perspective view of the ladder assembly of FIG. 7 in the retracted configuration attached to a tree;

FIG. 11 is a schematic, perspective view of the ladder assembly of FIG. 7 in a first intermediate configuration between the retracted configuration and an extended configuration;

FIG. 12 is a schematic, perspective view of the ladder assembly of FIG. 7 in a second intermediate configuration between the retracted configuration and the extended configuration;

FIG. 13 is a schematic, perspective view of the ladder assembly of FIG. 7 in the extended configuration;

FIG. 14 is a schematic, top view of an alternative step member configuration that is usable with the ladder assemblies of FIGS. 1 and 7;

FIG. 15 is a schematic, perspective view of an insert for use with the step member of FIG. 14;

FIG. 16 is another schematic, perspective view of the insert for use with the step member of FIG. 14;

FIG. 17 is a schematic, perspective view of a spring-loaded pin for use with the step member of FIG. 14;

FIG. 18 is a schematic, side view of a ladder assembly with the step member of FIG. 14, the insert of FIGS. 15 and 16, and the pin of FIG. 17;

FIG. 19 is a schematic, perspective view of a ladder assembly with the step member of FIG. 14, the insert of FIGS. 15 and 16, and the pin of FIG. 17;

FIG. 20 is a schematic, perspective view of a ladder subassembly in accordance with the claimed invention, the ladder subassembly being in a compact configuration;

FIG. 21 is a schematic, perspective view of the ladder subassembly of FIG. 20 in an extended configuration; and

FIG. 22 is a schematic, perspective view of a ladder apparatus comprised of a plurality of ladder subassemblies.

### DETAILED DESCRIPTION

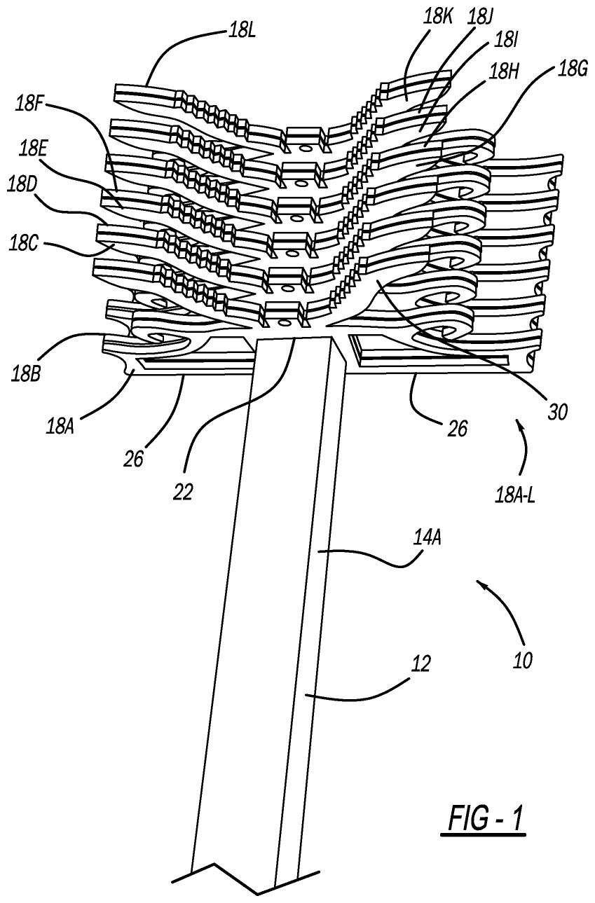

Referring to FIGS. 1-5, wherein like reference numbers refer to like components throughout, a ladder assembly 10 for use with trees or other substantially vertically-oriented supports is schematically depicted. The ladder assembly 10 includes a telescoping pole 12 having a first tube 14A, a second tube 14B, a third tube 14C, a fourth tube 14D, a fifth tube 14E, and a sixth tube 14F in telescoping relationship with each other. It should be noted that, although six tubes 14A-F are shown and described, any quantity of telescoping tubes may be used within the scope of the claimed invention.

Each of the tubes 14A-F is hollow and defines an interior space as understood by those skilled in the art. The tubes 14A-F in the embodiment depicted have a square cross-sectional shape to prevent rotation of the tubes 14A-F relative to one another. A portion of the second tube 14B extends into the interior space of the first tube 14A such that the first and second tubes 14A, 14B are in telescoping relationship with one another; that is, the first tube 14A is slidable with respect to the second tube 14B, with the inner wall of the first tube 14A limiting the movement of the second tube 14B to substantially linear translation. The second tube 14B remains at least partially within the interior space of the first tube 14A during this sliding movement.

Similarly, a portion of the third tube 14C extends into the interior space of the second tube 14B such that the second and third tubes 14B, 14C are in telescoping relationship with one another; that is, the second tube 14B is slidable with respect to the third tube 14C, with the inner wall of the second tube 14B limiting the movement of the third tube 14C to substantially linear translation. Likewise, a portion of the fourth tube 14D extends into the interior space of the third tube 14C such that the third and fourth tubes 14C, 14D are in telescoping relationship with one another; that is, the fourth tube 14D is slidable with respect to the third tube 14C, with the inner wall of the third tube 14C limiting the movement of the fourth tube 14D to substantially linear translation.

A portion of the fifth tube 14E extends into the interior space of the fourth tube 14D such that the fourth and fifth tubes 14D, 14E are in telescoping relationship with one another; that is, the fifth tube 14E is slidable with respect to the fourth tube 14D, with the inner wall of the fourth tube 14D limiting movement of the fifth tube 14E to substantially linear translation. A portion of the sixth tube 14F extends into the interior space of the fifth tube 14E such that the fifth and sixth tubes 14E, 14F are in telescoping relationship with one another; that is, the sixth tube 14F is slidable with respect to the fifth tube 14E, with the inner wall of the fifth tube 14E limiting movement of the sixth tube 14F to substantially linear translation.

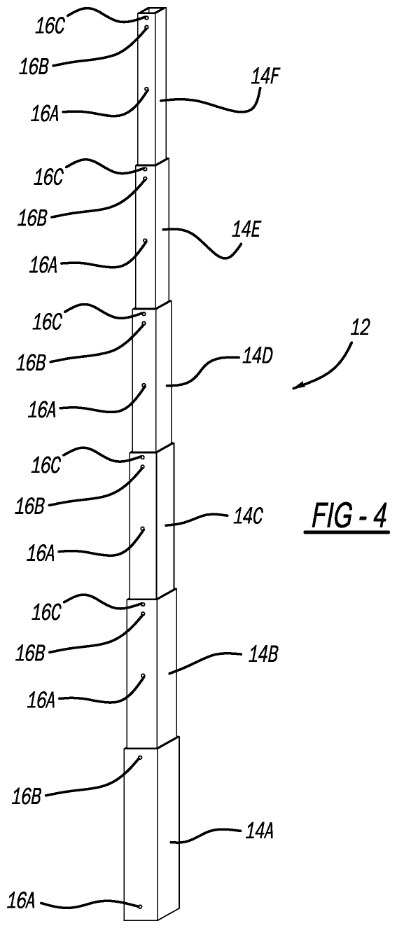

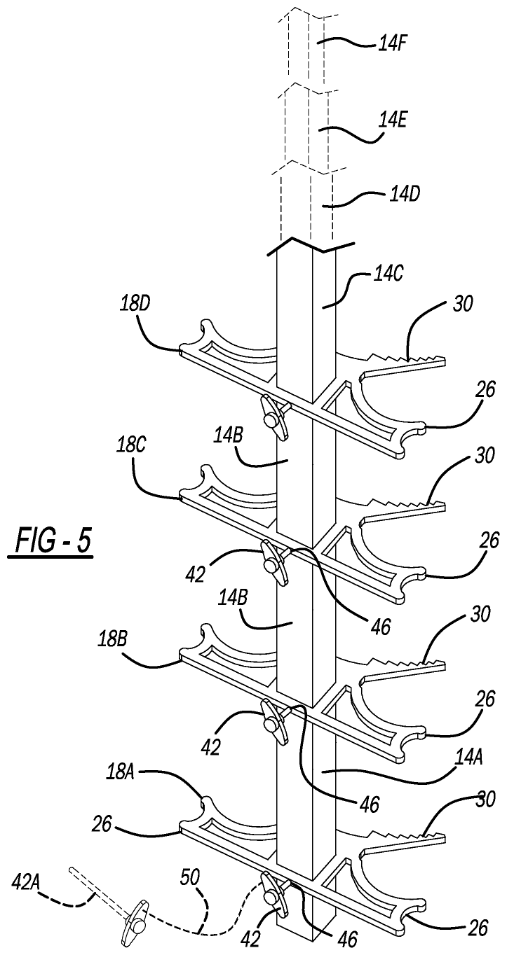

Thus, the pole 12 is selectively variable in length by sliding the tubes 14A-F relative to one another. More specifically, the pole 12 is characterized by a retracted configuration, as shown in FIGS. 1-3, and an elongated configuration, as shown in FIGS. 4 and 5. The length of the pole 12 is greater when the pole 12 is in the elongated configuration than when the pole 12 is in the retracted configuration. As shown in FIGS. 1-3, portions of the tubes 14A-F remain exposed and outside another of the tubes when the pole 12 is in the retracted configuration.

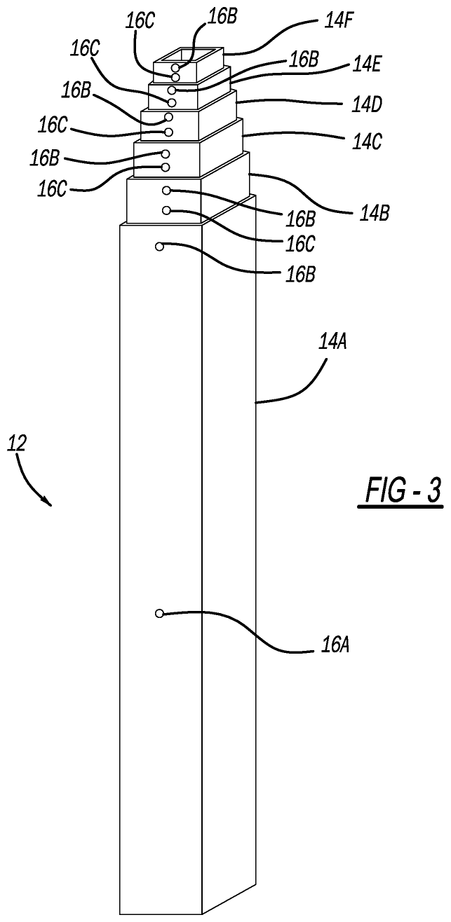

Tube 14A defines two holes 16A, 16B. Each of tubes 14B-F defines a respective three holes 16A, 16B, 16C. The hole 16A formed by each tube 14B-F is positioned at approximately the midpoint of the tube's length, and is therefore disposed within another tube when the pole 12 is in the retracted configuration, as shown in FIG. 3. In the embodiment depicted, the hole 16A formed by tube 14A is closer to the bottom of the tube 14A. Thus, when the pole 12 is in the retracted configuration, the holes 16A of tubes 14B-F are contained within another tube and not accessible. Holes 16B and 16C are formed in the portions of the tubes 14A-F that remain exposed when the pole 12 is in the retracted configuration, as shown in FIG. 3.

The ladder assembly 10 also includes a plurality of step members 18A-L. Each step member 18A-L defines a respective aperture 22. Each of the tubes 14A-14F extends through the aperture 22 of a respective two of the step members 18A-L. More specifically, the first tube 14A extends through the apertures 22 of first and second step members 18A, 18B; the second tube 14B extends through the apertures 22 of third and fourth step members 18C, 18D; the third tube 14C extends through the apertures 22 of fifth and sixth step members 18E, 18F; the fourth tube 14D extends through the apertures 22 of seventh and eighth step members 18G, 18H; the fifth tube 14E extends through the apertures 22 of ninth and tenth step members 18I, 18J; and the sixth tube 14F extends through the apertures 22 of eleventh and twelfth step members 18K, 18L.

Each step member 18A-L defines steps 26 that extend perpendicularly to the tubes 14A-F and the pole 12. Steps 26 are configured such that the steps 26 extend outward on two sides of the pole 12. Each step member 18A-L also defines a respective cleat 30 for engagement with a tree. More specifically, in the embodiment depicted, each cleat 30 is formed by two arms 34A, 34B that cooperate to define a generally U-shaped cavity 38. The surfaces of the arms 34A, 34B may be toothed as shown to increase friction between the step member 18A-L and the tree. Each step member 18A-L also defines a hole (shown at 46 in FIG. 5) extending therethrough. In the embodiment depicted, the step members 18A-L are substantially identical to one another except for the size of aperture 22, which is slightly larger than the tube that extends therethrough (each tube 14A-F has a different cross-sectional size).

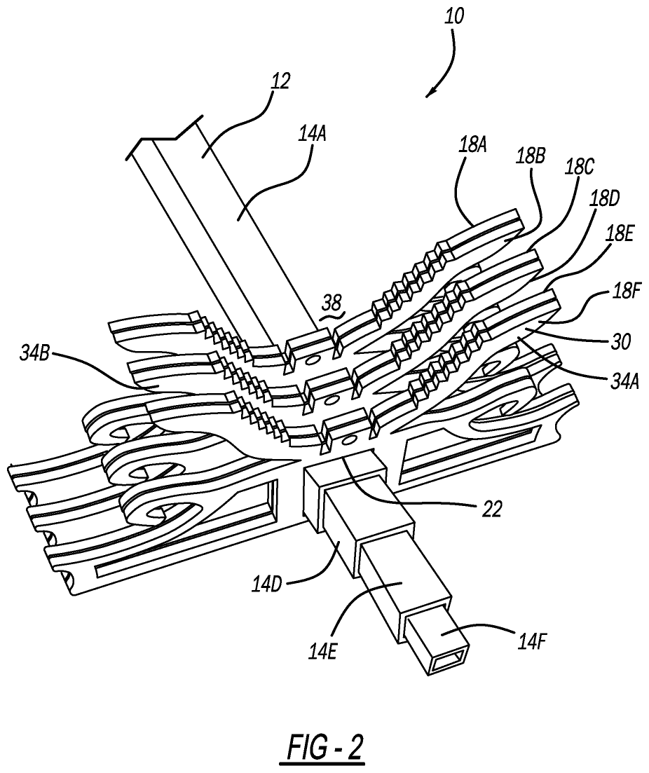

Each step member 18A-L is selectively movable with respect to the pole 12. More specifically, in the embodiment depicted, each step member 18A-L is selectively slidable along the tube that extends through its aperture 22. The ladder assembly 10 is movable or reconfigurable between a compact configuration, as shown in FIGS. 1 and 2, and an extended configuration, as shown in FIG. 5.

Referring to FIGS. 1 and 2, when the ladder assembly 10 is in the compact configuration, the pole 12 is in the retracted configuration, and the steps 18A-L are in respective stowed positions in which they contact portions of the tubes 14A-F that remain exposed and outside another tube. The ladder assembly 10 in the compact configuration has a significantly reduced length compared to the extended configuration, thereby making the ladder assembly easy to store and transport.

To move the ladder assembly 10 to the extended configuration, the ladder assembly 10 is placed in contact with a vertically-oriented support, such as the trunk of a tree, such that the cleats 30 engage the vertically-oriented support. The first tube 14A is secured to the vertically-oriented support, such as via a tether or strap. Step member 18A is moved along tube 14A until the hole 46 in step member 18A is aligned with the hole 16A of tube 14A. The ladder assembly 10 includes a plurality of pins 42; each step member 18A-L has a respective one of the pins 42 connected thereto by a cable 50 (only one of which is shown in phantom in FIG. 5). The pin 42 connected to step member 18A is then extended through the hole 46 of step member 18A and hole 16A of tube 14A, thereby securing the step member 18A relative to the tube 14A. The pin is shown in phantom at 42A prior to insertion into the hole 46.

Step member 18B is positioned such that the hole 46 of step member 18B is aligned with hole 16B of tube 14A, and the pin 42 connected to step member 18B is extended through the hole 46 of step member 18B and hole 16B of tube 14A thereby securing step member 18B relative to the tube 14A. Thus, tube 14A has steps 18A, 18B secured thereto.

Tube 14B is then moved upward such that the hole 16A of tube 14B is exposed, and step member 18C is positioned such that the hole 46 of step member 18C is aligned with the hole 16A of tube 14B and the pin 42 connected to step member 18C is extended through the hole 46 of step member 18C and the hole 16A of tube 14B, thereby securing step member 18C relative to tube 14B. Step member 18D is positioned such that the hole 46 of step member 18D is aligned with hole 16C of tube 14B, and the pin 42 connected to step member 18D is extended through the hole 46 of step member 18D and hole 16C of tube 14B thereby securing step member 18D relative to the tube 14B.

Tube 14C is then moved upward such that the hole 16A of tube 14C is exposed, and step member 18E is positioned such that the hole 46 of step member 18E is aligned with the hole 16A of tube 14C and the pin 42 connected to step member 18E is extended through the hole 46 of step member 18E and the hole 16A of tube 14C, thereby securing step member 18E relative to tube 14C. Step member 18F is positioned such that the hole 46 of step member 18F is aligned with hole 16C of tube 14C, and the pin 42 connected to step member 18F is extended through the hole 46 of step member 18F and hole 16C of tube 14C thereby securing step member 18F relative to the tube 14C.

The method includes performing the same actions performed with tubes 14B and 14C with the remaining tubes 14D-F such that the remaining tubes 14D-F have a step member attached at the tube's hole 16A and a step member attached at the tubes hole 16C. Thus, when the ladder assembly 10 is in the fully extended configuration, the pole 12 is in the fully elongated configuration, and for each tube 14A-F, a pin 42 extends through the hole 16A of the tube and the hole 46 of one of the step members 18A-L, and a pin 42 extends through the hole 16C of the tube and the hole 46 of another one of the step members 18A-L. Each tube 14A-F has two steps attached thereto. In the embodiment depicted, the tubes 14A-F are approximately three feet long; accordingly, step members 18A-L are spaced approximately one and a half feet apart.

Straps or tethers may be employed at various points along the length of the ladder assembly 10 to secure it to the tree. In one embodiment, the straps may be hooked or otherwise connected to the arms 34A, 34B of one or more of the cleats 30 and wrap around the tree.

It should be noted that other techniques for securing the step members 18A-L relative to the pole 12 may be employed within the scope of the claimed invention. For example, pins 42 may extend through holes 16A, 16B and a step member 18A-L rests atop the pin 42. In another embodiment, and within the scope of the claimed invention, some of the step members are permanently affixed, such as by welding, to tubes at portions of the tubes that are exposed when the pole is in the retracted configuration, with some of the step members being slidable or otherwise movable with respect to the tubes to permit the movement of the pole 12 to its retracted configuration.

When the ladder assembly 10 is moved to the compact position, the step members 16C, 16E, 16G, 16I, 16K may be moved to align with a respective one of holes 16B, and pins may be inserted into holes 16C.

Various materials may be employed within the scope of the claimed invention. In one embodiment, the tubes and/or step members are formed from lightweight aluminum alloys. The ladder assembly 10 also includes structure that selectively and releasably locks the tubes 14A-F to retain the pole 12 in its elongated configuration and, optionally, in its retracted configuration.

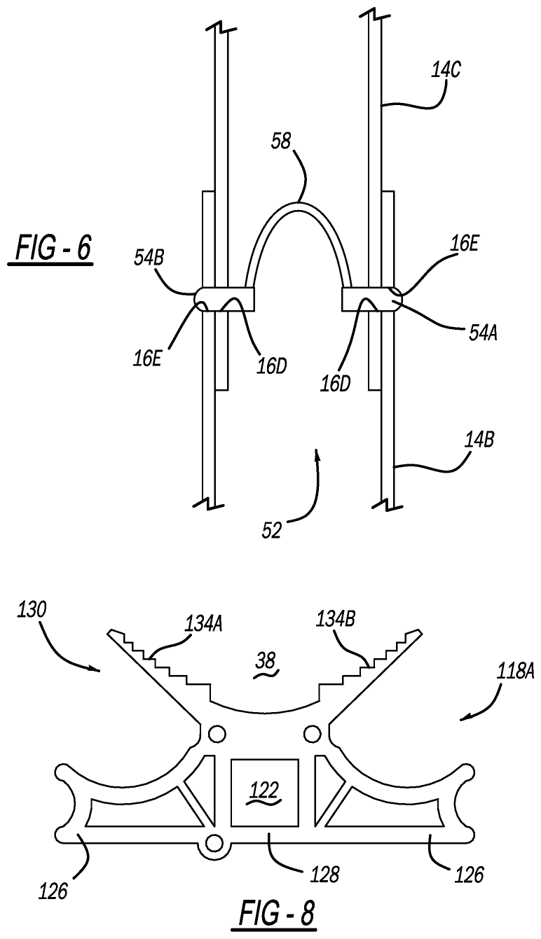

Those skilled in the art will recognize a variety of ways to releasably lock telescoping tubes relative to one another that may be employed within the scope of the claimed invention, including, but not limited to, pins that extend through aligned holes in adjoining tubes, spring-loaded pins that extend through holes in the tubes when the tube defining the hole is aligned with the pin, etc. FIG. 6, wherein like reference numbers refer to like components from FIGS. 1-5, schematically depicts an example of a spring-loaded pin configured to releasably lock telescoping tubes that may be used with the ladder assembly 10.

Referring to FIG. 6, wherein like reference numbers refer to like components from FIGS. 1-5, portions of tubes 14B and 14C are schematically depicted. Tube 14B defines two holes 16D that extend through opposite walls of the tube 14B. Similarly, tube 14C defines two holes 16E that extend through opposite walls of the tube 14C. A spring-loaded pin assembly 52 includes two pins 54A, 54B that are interconnected by a spring 58. The spring-loaded pin assembly 52 is positioned within the interior space of tube 14C, and each pin 54A, 54B extends into a respective one of holes 16D. The spring 58 biases the pins 54A, 54B in opposite directions.

When the tube 14B is positioned relative to tube 14C such that each of holes 16E is aligned with a respective one of holes 16D, then the spring 58 causes the pins 54A, 54B to also extend through holes 16E, thereby preventing relative movement between tubes 14B and 14C. The tubes 14B, 14C may be unlocked by pressing on the pins 54A, 54B with sufficient force to overcome the bias of the spring 58 and cause the pins 54A, 54B to move out of holes 16E. The ladder assembly 10 may include sufficient pin assemblies 52 to retain the pole 12 in its elongated configuration.

It should be noted that the ladder assembly 10 as shown includes only a single pole 12 with the steps 26 extending on opposite sides of the pole 12, as opposed to conventional ladders that have two poles with steps extending between the two poles.

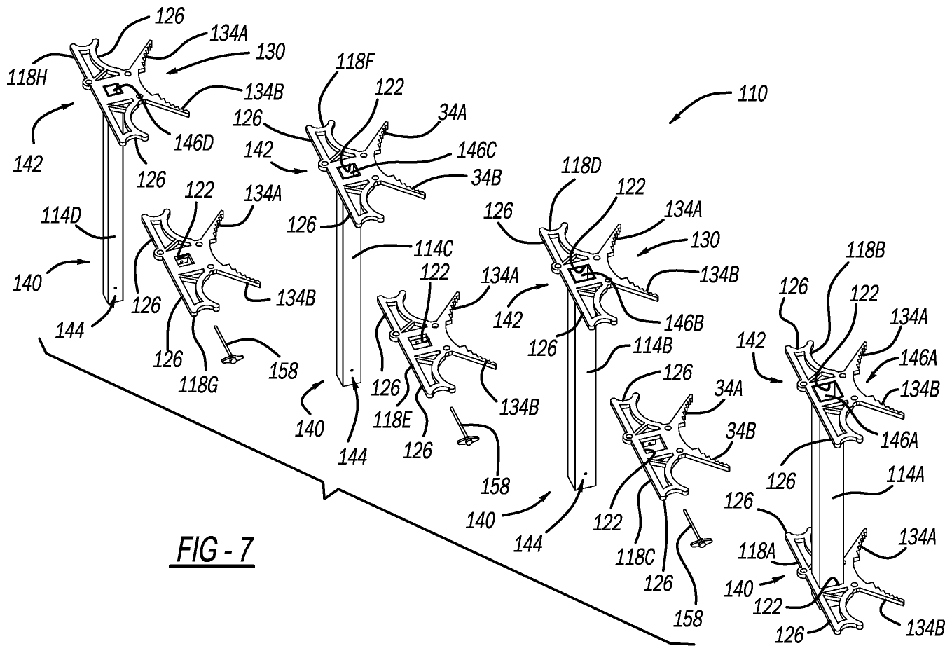

FIGS. 7-13, wherein like reference numbers refer to like components from FIGS. 1-5, schematically depicted another ladder assembly 110 in accordance with the claimed invention. Referring to FIG. 7, the ladder assembly 110 includes a plurality of tubes. In the embodiment depicted, the ladder assembly 110 includes a first tube 114A, a second tube 114B, a third tube 114C, and a fourth tube 114D. It should be noted that a ladder assembly 110 may have two or more tubes within the scope of the claimed invention.

The ladder assembly 110 also includes a plurality of step members 118A, 118B, 118C, 118D, 118E, 118F, 118G, 118H. FIG. 8 schematically depicts step member 118A, which is representative of the other step members 118B-H. Referring to FIG. 8, step member 118A defines an aperture 122. The step member 118A also defines steps 126 that extend outward in opposite directions from the central portion 128 of the step member 118A. In the embodiment depicted, the central portion 128 defines the aperture 122. The step member 118A also defines a cleat 130 for engagement with a tree. More specifically, in the embodiment depicted, the cleat 130 is formed by two arms 134A, 134B that cooperate to define a generally U-shaped cavity 138. The surfaces of the arms 134A, 134B may be toothed as shown to increase friction between the step member 118A and the tree.

In the embodiment depicted, the step members 118A-H are substantially identical to one another except for the size of aperture 122, which is slightly larger than the tube that extends therethrough (each tube 14A-D has a different cross-sectional size). In the embodiment depicted, the first tube 114A has step members 118A, 118B permanently mounted thereto, such as by welding. More specifically, the first tube 114A extends through the aperture 122 of step member 118A, which is welded to the first tube 114A at or near the lower end 140 of the tube 114A. The first tube 114A also extends through the aperture 122 of step member 118B, which is welded to the first tube 114A at or near the top end 142 of the tube 114A.

The second tube 114B extends through the aperture 122 of step member 118D, which is welded to the second tube 114B at or near the top end 142 of the tube 114B. The third tube 114C extends through the aperture 122 of step member 118F, which is welded to the third tube 114C at or near the top end 142 of the tube 114C. The fourth tube 114D extends through the aperture 122 of step member 118H, which is welded to the fourth tube 114D at or near the top end 142 of the tube 114D.

The second tube 114B extends through the hole 122 of step member 118C such that step member 118C is slidable along the length of the second tube 114B. The third tube 114C extends through the hole 122 of step member 118E such that step member 118E is slidable along the length of the third tube 114C. The fourth tube 114C extends through the hole 122 of step member 118G such that step member 118G is slidable along the length of the fourth tube 114D. Each of the tubes 114B-D defines a respective hole 144 near the tube's lower end 140, as shown in FIG. 7.

Each of the tubes 114A-D is hollow and defines a respective interior space 146A, 146B, 146C, 146D. More specifically, the first tube 114A defines interior space 146A; the second tube 114B defines interior space 146B; the third tube 114C defines interior space 146C; and the fourth tube 114D defines interior space 146D. The tubes 114A-D in the embodiment depicted have a square cross-sectional shape. The cross-sectional dimensions of the interior space 146A is slightly larger than the cross-sectional dimensions of the second tube 114B; the cross-sectional dimensions of the interior space 146B is slightly larger than the cross-sectional dimension of the third tube 114C; and the cross-sectional dimensions of the interior space 146C is slightly larger than the cross-sectional dimensions of the fourth tube 114D.

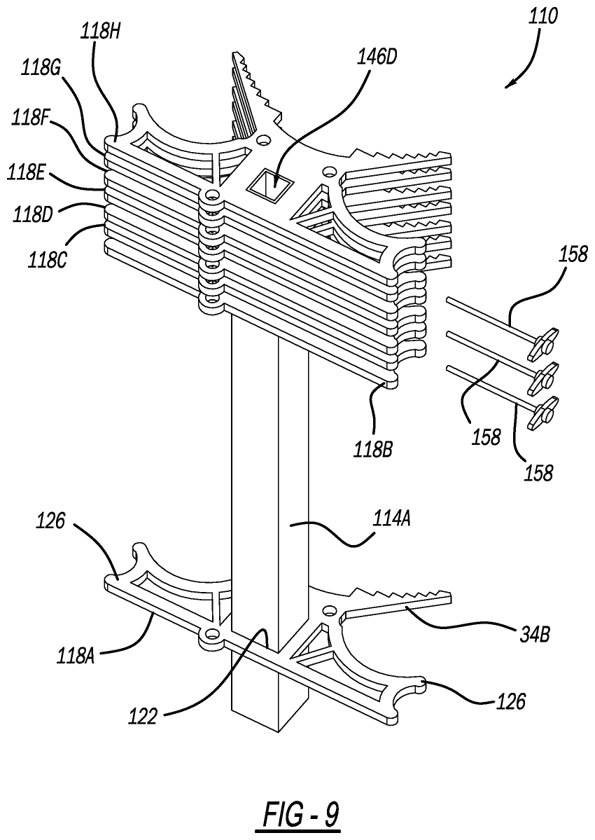

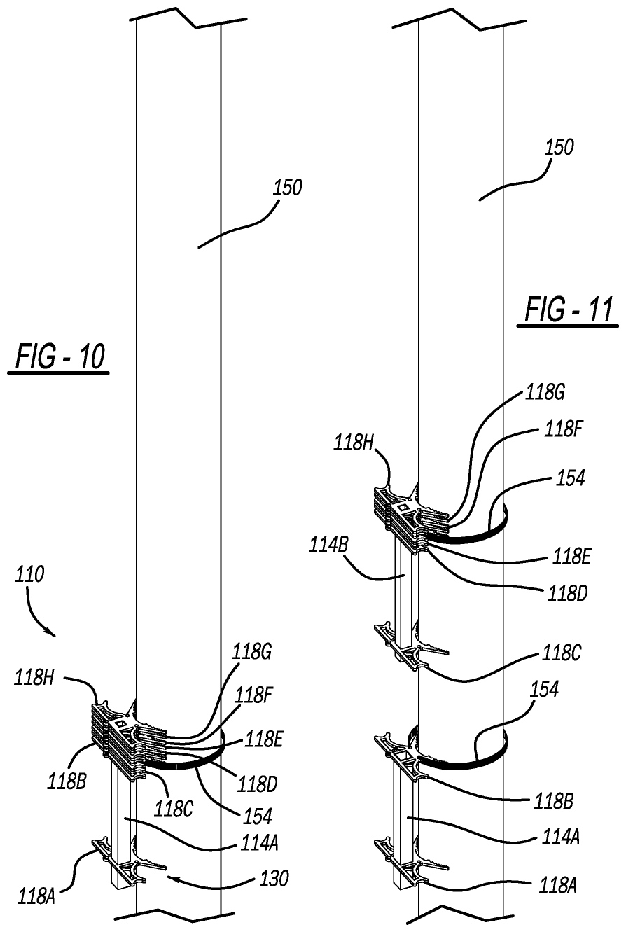

The ladder assembly 110 is reconfigurable between a retracted configuration, as shown in FIGS. 9 and 10, and an extended configuration, as shown in FIG. 13. Referring to FIG. 9, the tubes 114A-D are nestingly engaged with one another. More specifically, the second tube 114B is substantially entirely disposed within the interior space 146A of the first tube 114A; the third tube 114C is substantially entirely disposed within the interior space 146B of the second tube 114B; and the fourth tube 114D is substantially entirely disposed within the interior space 146C of the third tube 114C. It should be noted that the hole 144 of each tube 114B, 114C, 114D is within the interior space of another of the tubes, and is therefore unexposed and unreachable by the movable step members 118C, 118E, 188G, when the ladder assembly 110 is in the retracted configuration.

Step member 118C is positioned between step members 118B and 118D; step member 118E is positioned between step members 118D and 118F; step member 118G is positioned between step members 118F and 118H. The step members 118C-H cannot be inserted into the interior spaces 146A-D; accordingly, the step members, along with a small portion of the upper end of each tube 114B, 114C, 114D, remain outside any of the interior spaces 146A-D. In the embodiment depicted, when the ladder assembly 110 is in the retracted configuration, the step members 118C-H are in contact with adjacent step members or are in close proximity to adjacent step members.

FIGS. 10-13 schematically depict a method of using the ladder assembly 110 and moving the ladder assembly 110 from the retracted configuration to the extended configuration. Referring to FIG. 10, the method includes attaching the first tube 114A to a tree 150, such as with a strap 154, when the ladder assembly 110 is in the retracted configuration. The first tube 114A is attached to the tree 150 such that the first tube 114A extends substantially vertically as shown and the cleats 130 of step members 118A, 118B contact the tree 150. The method further includes removing the second, third and fourth tubes 114B-D from the interior space 146A of the first tube 114A and moving the tubes 114B-D together as a single unit, i.e., with the third tube 114C and the fourth tube 114D in nesting engagement with the second tube 114B, to a position above the first tube 114A, as shown in FIG. 11.

Referring to FIG. 11, the method also includes inserting a pin (shown at 158 in FIGS. 6 and 8) in the hole 144 of the second tube 114B, sliding step member 118C along the second tube 114B until the step member 118C rests on the pin 158, and attaching the second tube 114B to the tree 150 in the position shown with another strap 154 such that the cleats 130 of step members 118C and 118D contact the tree 150.

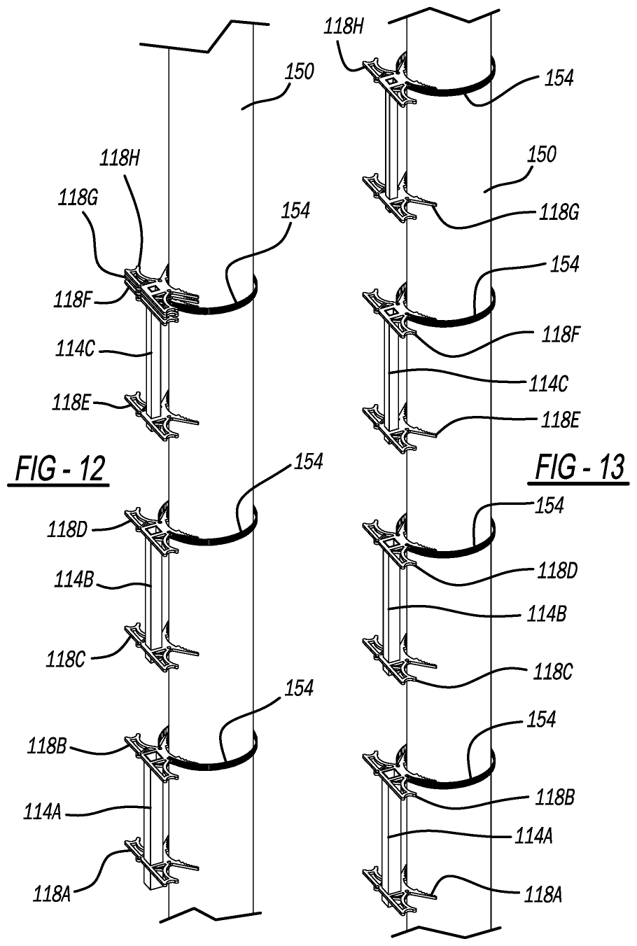

The method also includes removing the third and fourth tubes 114C-D from the interior space 146B of the second tube 114B and moving the tubes 114C-D together as a single unit, i.e., with the fourth tube 114D in nesting engagement with the third tube 114C, to a position above the first tube 114A and the second tube 114B, as shown in FIG. 12.

Referring to FIG. 12, the method also includes inserting a pin (shown at 158 in FIGS. 6 and 8) in the hole 144 of the third tube 114C, sliding step member 118E along the third tube 114C until the step member 118E rests on the pin 158, and attaching the third tube 114C to the tree 150 in the position shown with another strap 154 such that the cleats 130 of step members 118E and 118F contact the tree 150.

The final steps in moving the ladder assembly 110 to the extended position include removing the fourth tube 114D from the interior space 146C of the third tube 114C and moving the fourth tube 114D to a position above the first tube 114A, the second tube 114B, and the third tube 114C as shown in FIG. 13.

Referring to FIG. 13, the method also includes inserting a pin (shown at 158 in FIGS. 6 and 8) in the hole 144 of the fourth tube 114D, sliding step member 118G along the fourth tube 114D until the step member 118G rests on the pin 158, and attaching the fourth tube 114D to the tree 150 in the position shown with another strap 154 such that the cleats 130 of step members 118G and 118H contact the tree 150.

Ladder assembly 110 enables a hunter or other user of the ladder assembly 110 to reach a height in the tree 150 with fewer tubes than would be required for ladder assembly 10 to reach the same height. More specifically, because the tubes 114A-D of ladder assembly 110 are separable, they can be spaced apart vertically in the extended configuration as shown in FIG. 13, while still providing an appropriate vertical distance between step members for the hunter to climb. Thus, ladder assembly 110 provides the same functionality as ladder assembly 10 with fewer parts and significantly lighter weight, which is important when carrying the ladder assembly 110 to remote areas. In one embodiment, the vertical distance between the tubes when the ladder assembly 110 is in the extended configuration as shown in FIG. 1 is between one and two feet, and more preferably is one and a half feet.

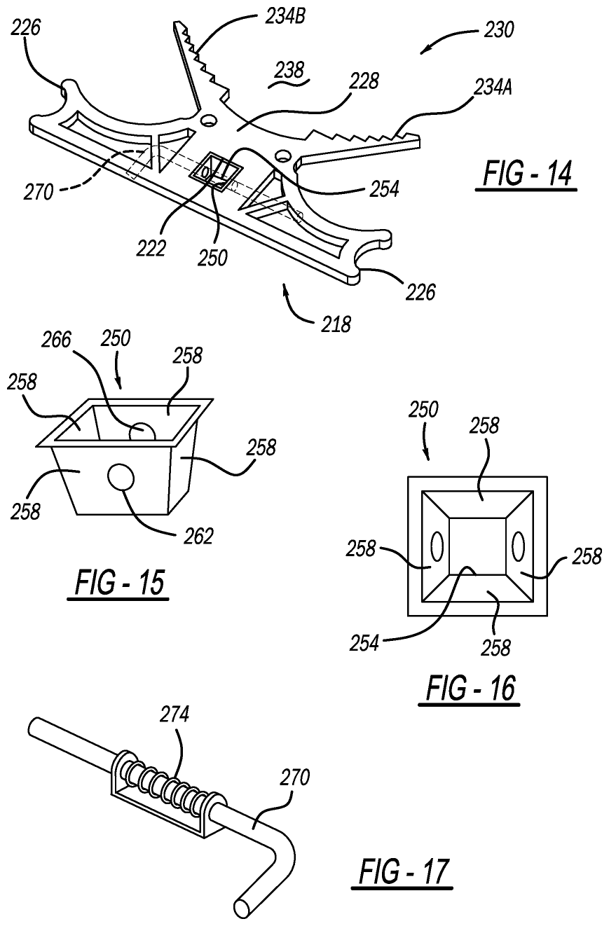

FIG. 14 schematically depicts an alternative step member 218 that may be employed with the ladder assemblies 10, 110. Referring to FIG. 14, wherein like reference numbers refer to like components from FIGS. 1-13, step member 218 is substantially similar to step members 118, i.e., step member 218 defines steps 226 that extend outward in opposite directions from the central portion 228 of the step member 218. In the embodiment depicted, the central portion 228 defines an aperture 222. The step member 218 also defines a cleat 230 for engagement with a tree. More specifically, in the embodiment depicted, the cleat 230 is formed by two arms 234A, 234B that cooperate to define a generally U-shaped cavity 238. The surfaces of the arms 234A, 234B may be toothed as shown to increase friction between the step member 218 and the tree.

The step member 218 is configured such that an insert 250 is insertable into the aperture 222. Referring to FIGS. 14-16, the insert 250 is sized such that the insert 250 contacts all surfaces of step member 218 that cooperate to define the aperture 222. Accordingly, in the embodiment depicted, the insert 250 has a square cross-sectional shape. The insert 250 also defines an aperture 254 that extends through the insert 250. The aperture 254 is slightly larger than the tube of ladder assembly 10 or 110 that extends therethrough. A ladder assembly may thus have step members all having the same sized aperture 222, but having inserts 250 of differing aperture 254 sizes to accommodate the different tubes.

The insert 250 includes four walls 258 that cooperate to define the aperture 254. The walls 258 are configured such that, when the insert 250 is inserted into aperture 222 as shown, the walls 254 extend below the step member 218. One of the walls 258 defines a hole 262, and another wall 258 defines a hole 266 on the opposite side of the aperture 254 from hole 262.

The holes 262, 266 are configured to align with holes on one of the tubes in the ladder assembly; a spring-loaded pin 270 is operative connected to the step member 218 and is positioned to selectively extend through holes 262 and 266. Thus, when the holes 262 and 266 are aligned with holes in the tube and the pin 270 extends through the holes in the tube and holes 262, 266, the step member is locked relative to the tube.

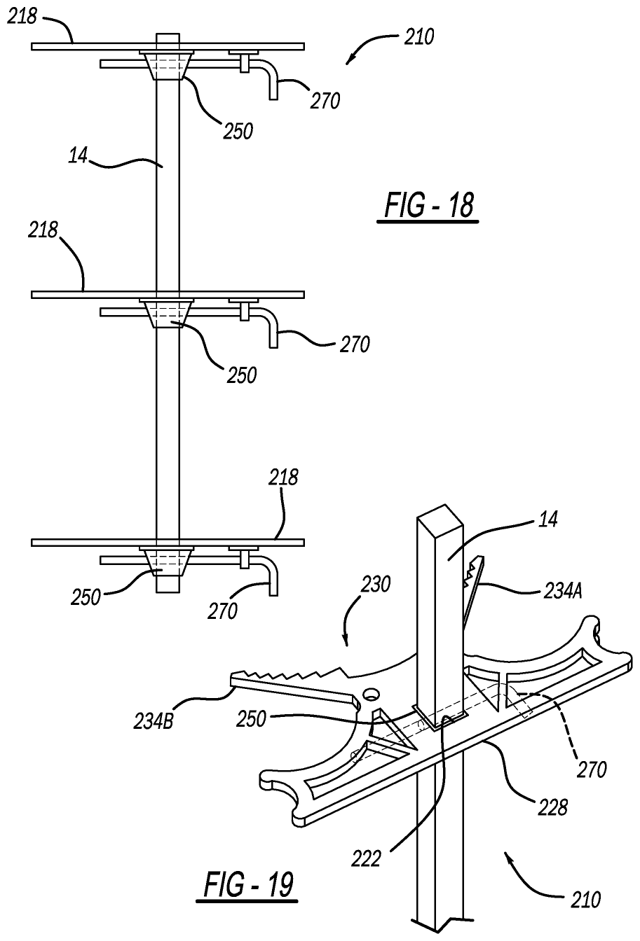

Referring to FIG. 17, wherein like reference numbers refer to like components from FIGS. 1-16, a spring 274 may be operatively connected to the pin 270 to bias the pin 270 into engagement with the holes 262, 266. Referring to FIGS. 18 and 19, wherein like reference numbers refer to like components from FIGS. 1-17, a ladder assembly 210 includes at least one tube 14 and a plurality of step members 218, each having the insert 250 in the aperture 222, the pin 270 operatively connected to the step member 218 and extending through the holes in the inserts 250 and holes in the tube 14. As shown in FIGS. 16 and 19, the holes 262, 266 are below each step member 218. The step members 218 may become slidable relative to the tube 14 by pulling on the pins 270 such that the spring bias is overcome and the pin is removed from the holes.

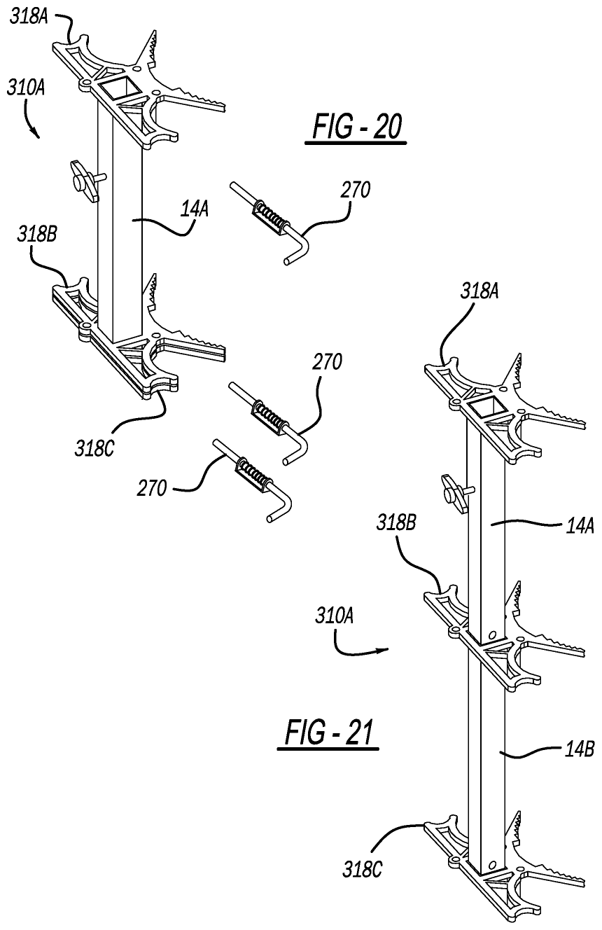

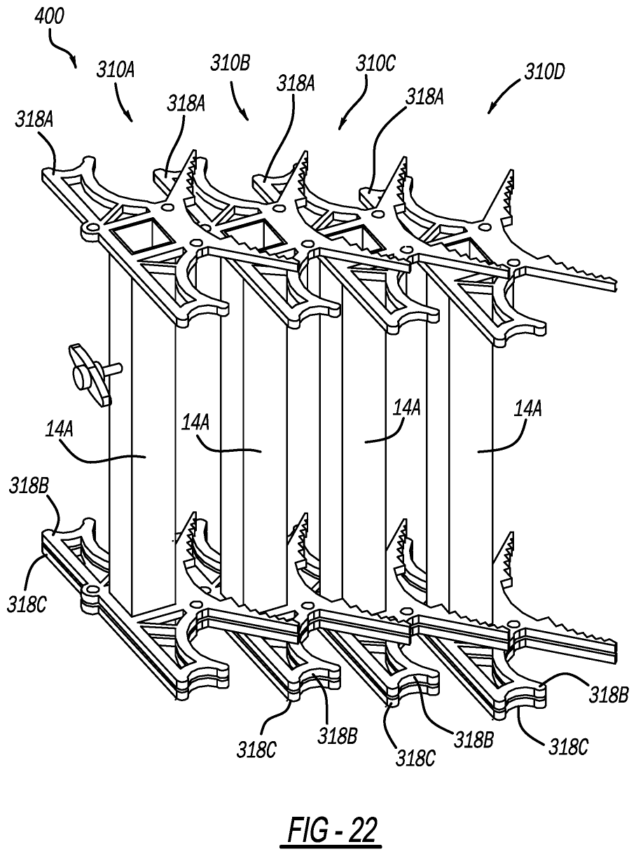

Referring to FIGS. 20-22, wherein like reference numbers refer to like components from FIGS. 1-19, another ladder system 400 is schematically depicted. Referring specifically to FIG. 22, the ladder system 400 includes a plurality of ladder subassemblies 310A, 310B, 310C, 310D. In the embodiment depicted, the ladder system 400 includes four of the subassemblies 310A-D, though two or more may be employed within the scope of the claimed invention. The ladder subassemblies 310A, 310B, 310C, 310D are substantially identical to one another. Ladder subassembly 310A is schematically depicted in FIGS. 20 and 21 and is representative of the other ladder subassemblies 310B, 310C, 310D.

Referring specifically to FIGS. 20 and 21, ladder subassembly 310A includes two telescoping tubes 14A, 14B. Tube 14A has a first step member 318A mounted thereto at one end and a second step member 318B mounted at the other end. Tube 14B is partially inserted within tube 14A such that the tube 14B is selectively slidable relative to tube 14A between a retracted position in which substantially all the tube 14B is disposed within tube 14A, as shown in FIG. 20, and an extended position, in which a significant amount of the tube 14B is removed from tube 14A as shown in FIG. 21 to lengthen the ladder subassembly 310A.

The ladder subassembly 310A may include locking features such as the one shown in FIG. 6 to releasably retain the tube 14B in the extended and retracted positions. A third step member 318C is mounted to one end of tube 14B so that the third step 318C is adjacent to or in contact with the second step member 318B when the tube 14B is in the retracted position and is separated from the second step member 318B when the tube 14B is in the extended position.

In the embodiment depicted, the step members 318A-C are connected to their respective tubes by a pin 270, but may be connected by other techniques such as welding within the scope of the claimed invention.

The tube 14B and the third step 318C are thus stowable and result in a compact ladder subassembly, but the third step member 318C is movable to a usable position by extending the tube 14B. Step members 318A-318C are substantially similar to the step members shown at 118A in FIG. 8, and include cleats. The ladder subassemblies 310A-D are nestable as shown in FIG. 22, with the tubes 14B of each subassembly in their respective retracted position, and the tubes 14A nested within the cavity formed by the cleats of an adjacent subassembly.

One method of using the ladder system 400 includes securing ladder subassembly 310A to a tree, such as the one shown at 150 in FIGS. 10-13, such as with a strap, and then moving the tube 14B of the subassembly 310A to its extended position. The method further includes securing ladder subassembly 310B to the tree at a height above ladder subassembly 310A and extending the tube 14B of the subassembly 310B to its extended position. The method may include mounting subassemblies 310C, 310D to the tree and extending their tubes 14B such that subassembly 310C is above subassembly 310B and subassembly 310D is above subassembly 310C.

While the best modes for carrying out the disclosure have been described in detail, those familiar with the art to which this disclosure relates will recognize various alternative designs and embodiments for practicing the disclosure within the scope of the appended claims.

1. A ladder assembly comprising:
first and second tubes;
said first tube defining a first interior space;
first, second, third, and fourth step members;
said first step member being mounted to a first end of the first tube;
said second step member being mounted to a second end of the first tube;
said third step member being operatively connected to the second tube such that the third step member is selectively slidable along the length of the second tube;
said fourth step member being mounted to a first end of the second tube;
said ladder assembly being reconfigurable between a retracted configuration and an extended configuration;
wherein the second tube is nested within the interior space of the first tube, and the third step member is adjacent the fourth step member when the ladder assembly is in the retracted configuration; and
wherein the second tube is separated from the first tube and the third step member is mounted to a second end of the second tube when the ladder assembly is in the extended configuration.

2. The ladder assembly of claim 1, further comprising a third tube;
a fifth step member being operatively connected to the third tube such that the fifth step member is selectively slidable along the length of the third tube;
a sixth step member being mounted to a first end of the third tube;
wherein the second tube defines a second interior space;
wherein the third tube is nested within the second interior space of the second tube and the fifth step member is adjacent the sixth step member when the ladder assembly is in the retracted configuration; and
wherein the third tube is separated from the first and second tubes and the fifth step member is mounted to a second end of the third tube when the ladder assembly is in the extended configuration.

3. The ladder assembly of claim 2, further comprising a fourth tube;
a seventh step member being operatively connected to the fourth tube such that the seventh step member is selectively slidable along the length of the fourth tube;
an eighth step member being mounted to a first end of the fourth tube;
wherein the third tube defines a third interior space;
wherein the fourth tube is nested within the third interior space of the third tube and the seventh step member is adjacent the eighth step member when the ladder assembly is in the retracted configuration; and
wherein the fourth tube is separated from the first, second, and third tubes and the seventh step member is mounted to a second end of the fourth tube when the ladder assembly is in the extended configuration.

4. A method comprising:
possessing a ladder assembly having first and second tubes; said first tube defining a first interior space; first, second, third, and fourth step members; said first step member being mounted to a first end of the first tube; said second step member being mounted to a second end of the first tube; said third step member being operatively connected to the second tube such that the third step member is selectively slidable along the length of the second tube; said fourth step member being mounted to a first end of the second tube; said ladder assembly being in a retracted configuration in which the second tube is nested within the interior space of the first tube, and the third step member is adjacent the fourth step member;
attaching the ladder assembly to a tree;
separating the second tube and the first tube by completely removing the second tube from the first interior space;
moving the third step member to a position adjacent the lower end of the second tube and securing the third step member adjacent the lower end of the second tube;
moving the second tube to a height above the first tube; and
attaching the second tube to the tree.

5. The method of claim 4, wherein said attaching the second tube to the tree includes attaching the second tube to the tree such that there is between one and two feet of vertical distance between the first tube and the second tube.

6. The method of claim 4, wherein the ladder assembly further includes a third tube; a fifth step member being operatively connected to the third tube such that the fifth step member is selectively slidable along the length of the third tube; a sixth step member being mounted to a first end of the third tube; wherein the second tube defines a second interior space; wherein the third tube is nested within the second interior space of the second tube and the fifth step member is adjacent the sixth step member when the ladder assembly is in the retracted configuration.

7. The method of claim 6, wherein said separating the second tube and the first tube by completely removing the second tube from the first interior space is performed with the third tube nested within the second interior space of the second tube.

8. The method of claim 7, wherein said moving the third step member to a position adjacent the lower end of the second tube and securing the third step member adjacent the lower end of the second tube is performed with the third tube nested within the second interior space of the second tube.

9. The method of claim 6, further comprising separating the third tube and the second tube by completely removing the third tube from the second interior space;
moving the fifth step member to a position adjacent the lower end of the third tube and securing the fifth step member adjacent the lower end of the third tube;
moving the third tube to a height above the second tube; and
attaching the third tube to the tree.

10. The method of claim 9, wherein said attaching the third tube to the tree includes attaching the third tube to the tree such that there is between one and two feet of vertical distance between the second tube and the third tube.
